(19) United States
(12) Patent Application Publication
(10) Pub. No.: US 2008/0298648 A1
(43) Pub. Date: Dec. 4, 2008

(54) METHOD AND SYSTEM FOR SLAP PRINT SEGMENTATION

(75) Inventors: Peter Z. Lo, Lake Forest, CA (US); Behnam Bavarian, Newport Coast, CA (US); Ying Luo, Irvine, CA (US)

Correspondence Address: MOTOROLA, INC., 1303 EAST ALGONQUIN ROAD, IL01/3RD, SCHAUMBURG, IL, 60196, US

(73) Assignee: MOTOROLA, INC., SCHAUMBURG, IL (US)

(21) Appl. No.: 11/756,148

(22) Filed: May 31, 2007

(51) Int. Cl. G06K 9/00

(52) U.S. Cl. 382/125

(57) ABSTRACT

A method is performed in a print identification system to segment a non-segmented slap print image into its finger components. The method includes: receiving, for a hand, a non-segmented slap print image and a corresponding plurality of roll print images each corresponding to a different finger number; comparing the roll print images to the non-segmented slap print image to determine a number of mated minutiae areas on the non-segmented slap print image; detecting a number of print components from the non-segmented slap print image using the plurality of mated minutiae areas; and selecting a number of final print components from the detected print components and assigning finger numbers to the final print components, using the plurality of mated minutiae areas.

### TECHNICAL FIELD

The technical field relates generally to print identification systems and more particularly to segmenting a non-segmented slap print image into its finger components.

### BACKGROUND

Identification pattern systems, such as ten prints or fingerprint identification systems, play a critical role in modern society in both criminal and civil applications. For example, criminal identification in public safety sectors is an integral part of any present day investigation. Similarly in civil applications such as credit card or personal identity fraud, print identification has become an essential part of the security process.

An automatic fingerprint identification operation normally consists of two stages. The first is the registration stage, and the second is the identification stage. In the registration stage, the register's prints (as print images) and personal information are enrolled, and features, such as minutiae, core, delta, and classification type, are extracted. Classification type may be, for example, whorl, left loop, right loop, tented arch, and plain arch. Moreover, image quality at individual pixel locations or at blocks of pixels within the direction image can be determined using any suitable means, to facilitate implementations of various embodiments. An illustrative scale for image quality is from 0 in to 100 in, with 0 in being a lowest quality and 100 in being a highest quality. Direction images and ridge frequency maps based on the print images may also be generated depending on the particular matching algorithm being implemented.

The personal information and the extracted features (and perhaps the print images, direction images and ridge frequency maps) are then used to form a file record that is saved into a database for subsequent print identification. These features may be stored as a template with a standard exchangeable format. Moreover, since storage of a direction image (or other print image) in a regular format can use more storage space than is desirable for some implementations, the direction images may alternatively be quantized into a smaller range of values, and the direction images may further be compressed using any suitable image or data compression technique to minimize storage requirements. For example, the number of directions in a direction image may be quantized into M and the dimensionality of the direction image reduced to RxC from RnxCn for computational efficiency, wherein a block (of pixels) represents (RnxCn/RxC) pixels. Present day automatic fingerprint identification systems (AFIS) may contain several hundred thousand to a few million of such file records.

In the identification stage, print features from an individual, or latent print, and personal information are extracted to form what is typically referred to as a search record. The search record is then compared with the enrolled file records in the database of the fingerprint matching system. In a typical search scenario, a search record may be compared against millions of file records that are stored in the database and a list of match scores is generated after the matching process. Candidate records are sorted according to match scores. A match score is a measurement of the similarity of the print features of the identified search and file records. The higher the score, the more similar the file and search records are determined to be. Thus, a top candidate is the one that has the closest match.

In an AFIS, fingerprint data can be collected in the form of fourteen inked impressions on a traditional ten print card or in the form of fourteen scanned images captured using a workstation that includes a scanner. The fourteen impressions (images) comprises rolled impressions (images) of the ten fingers as well as four slap impressions (images), i.e., a left slap (the four fingers of the left hand), a right slap (the four fingers of the right hand) and thumb slaps (of the left and right thumbs). The initially captured left and right slap are each also referred to herein as a “non-segmented slap print image” prior to the slap print image undergoing a segmentation process to segment the image into its corresponding finger components.

Validating the accuracy of such captured print images is generally accomplished by first segmenting the non-segmented slap print images and then matching each rolled (or flat fingerprint images) against the corresponding finger component of a slap print (preferably taken from both hands of the owner), which is referred to as the rolled to slap comparison or RTS. The validation of this comparison critically depends on the accuracy of the segmentation process, including preserving captured data from top regions of the fingers.

One method of insuring proper segmentation is to visually inspect and manually correct each segmented finger component. However, the amount of time and energy needed to manually review enrolled cards (images) for a large AFIS system is a drain on resources, which are becoming more stretched as the demand for faster and more accurate identification systems are required. Accordingly, more systems incorporate some form of automated process for slap print segmentation. However, these processes suffer from some shortcomings.

For example, in accordance with some print segmentation algorithms, a simple top edge center point or the centroid of a component is used to facilitate print image segmentation. However, such algorithms are more suitable to single print segmentation and have limited use in segmenting slap print images. This is because since enrolled slap print images are often rotated or not oriented properly on the media in which they are captured, a simple top edge center point or the centroid of a component does not result in the accurate assignment of the proper finger number to detected components.

For example, if a right hand slap impression is rotated more than 45 degrees toward the left side of the print, the top edge of the middle fingerprint (finger #3) component may be closer to left side edge of the print than that of the index fingerprint (#2) component. If a right hand slap impression is rotated more than 45 degrees toward to the right side of the print, the top edge of the middle finger (finger #3), and the ring finger (finger #4) may be closer to right side edge of the print than that of the little finger (finger #5). If one uses a rule that finger #5 is most closest to the right side of the print and finger #2 is the most closest to the left side of the print, then the finger numbers will be wrongly assigned when the fingerprint slap impression are rotated as described above.

To address these shortcomings, some improved methods have been developed that are particularly directed to segmenting slap print images. In accordance with one such method, the relative orientation and placement of image components are detected. Zone lines of each component are found and zone areas defined, and the finger numbers are assigned in accordance with an anchor print component and geometrical relationship among the components. However, such methods are still deficient in addressing shortcomings associated with the manner in which the slap print is captured.

More particularly, a slap fingerprint image that is captured with uneven pressure, an under-inked impression, or an excessively dry finger, may lead to several components on a single finger, a large component linking several fingerprint components, or a missing fingerprint component. Additionally, to improve segmentation speed, the images are often down sampled and scale level quantized, which typically worsens the problem. These print image capture limitations lead to some components not being properly segmented, e.g., a fingerprint component is missed, a component size is incorrectly estimated due to complexity of the various gray level differences in the slap image, etc., which leads to a wrong finger number assignment and, thereby, inaccuracies in validating the captured print images.

Thus, there exists a need for a method and system of slap print image segmentation, which addresses at least some of the shortcomings of past and present techniques and mechanisms.

### BRIEF DESCRIPTION OF THE FIGURES

The accompanying figures, where like reference numerals refer to identical or functionally similar elements throughout the separate views, which together with the detailed description below are incorporated in and form part of the specification and serve to further illustrate various embodiments of concepts that include the claimed invention, and to explain various principles and advantages of those embodiments.

FIG. 1 illustrates a block diagram of an AFIS implementing some embodiments.

FIG. 2 illustrates a method in accordance with some embodiments.

FIG. 3 illustrates a method in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help improve understanding of various embodiments. In addition, the description and drawings do not necessarily require the order illustrated. Apparatus and method components have been represented where appropriate by conventional symbols in the drawings, showing only those specific details that are pertinent to understanding the various embodiments so as not to obscure the disclosure with details that will be readily apparent to those of ordinary skill in the art having the benefit of the description herein. Thus, it will be appreciated that for simplicity and clarity of illustration, common and well-understood elements that are useful or necessary in a commercially feasible embodiment may not be depicted in order to facilitate a less obstructed view of these various embodiments.

### DETAILED DESCRIPTION

Generally speaking, pursuant to the various embodiments, a method and system for segmenting slap print images is described. Embodiments use the mated minutiae areas of roll to non-segmented slap matching results as an initial area to find an exact area of fingerprint components. A gray statistical image and a set of four thresholds can initially be used to binarize the non-segmented slap image to detect fingerprint components. The detected components are compared with the mated minutiae areas, and the size of each component is analyzed to determine whether the components are correctly detected. If one or more components are incorrectly detected (e.g., a detected component does not include a mated minutiae area, the size of the component fails to meet a size threshold, a finger component is missing, etc.), in accordance with further embodiments the binarizing and component detection can be iteratively performed to obtain suitable fingerprint components. Moreover, during these iterations, binarizing is not limited to being based on the gray statistical image and fixed thresholds, but can be performed based on or more of the following: a different set of thresholds, using different image resolutions, the ridge frequency map, the direction map, and a gray statistical image on the original image. In this way, fingerprint components can be detected that preserve the corresponding fingerprint shape and size, which makes the remainder of the process, e.g., component merge, component split, etc., easier.

A final set of fingerprint components are selected from the detected components, and finger numbers are assigned to these final components. In selecting the final fingerprint components, boundary lines of each component are found and zone areas are defined. A component under a top component of each zone, which does not correspond to a mated minutiae area, is deleted. Moreover, the selecting and finger number assigning are performed not only based on geometrical relationship between components and relative distance between the tips of each component, but also based on the matching results between the roll and slap images. Those skilled in the art will realize that the above recognized advantages and other advantages described herein are merely illustrative and are not meant to be a complete rendering of all of the advantages of the various embodiments.

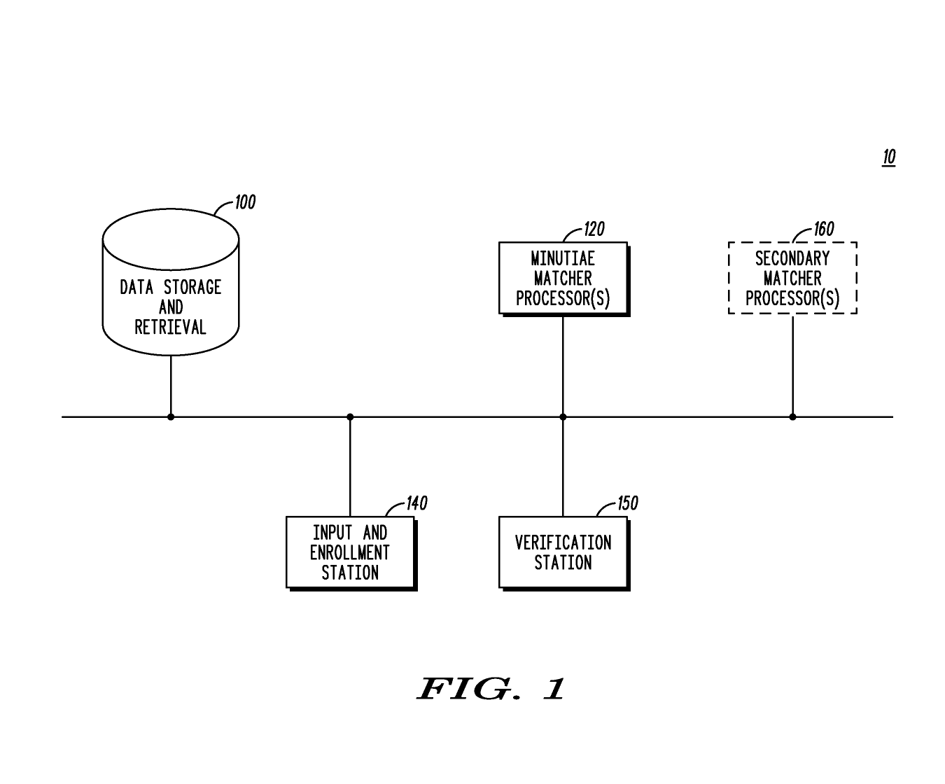

Referring now to the drawings, and in particular FIG. 1, a logical block diagram of an illustrative fingerprint matching system implementing some embodiments is shown and indicated generally at 100. Although fingerprints and fingerprint images is specifically referred to herein, those of ordinary skill in the art will recognize and appreciate that the specifics of this illustrative example are not specifics of the invention itself and that the teachings set forth herein are applicable in a variety of alternative settings. For example, since the teachings described do not depend on the type of print being analyzed, they can be applied to any type of print (or print image), such as toe prints (images). As such, other alternative implementations of using different types of prints are contemplated and are within the scope of the various teachings described herein.

System 100 is generally known in the art as an Automatic Fingerprint Identification System or (AFIS) as it is configured to automatically (typically using a combination of hardware and software) compare a given search print record (for example a record that includes an unidentified latent print image or a known ten-print) to a database of file print records (e.g., that contain ten-print records of known persons) and identify one or more candidate file print records that match the search print record. The ideal goal of the matching process is to identify, with a predetermined amount of certainty and without a manual visual comparison, the search print as having come from a person who has print image(s) stored in the database. At a minimum, AFIS system designers and manufactures desire to significantly limit the time spent in a manual comparison of the search print image to candidate file print images (also referred to in the art as respondent file print images).

Before describing system 100 in detail, it will be useful to define terms that are used herein and with regards to print matching.

A print is a pattern of friction ridges (also referred to in the art as “ridges”), which are raised portions of skin, and valleys between the ridges on the surface of a finger (fingerprint), toe (toe print) or palm (palm print), for example.

A print image is a visual representation of a print that is stored in electronic form.

A gray scale image is a data matrix that uses values, such as pixel values at corresponding pixel locations in the matrix, to represent intensities of gray within some range. An example of a range of gray-level values is 0 to 255.

Image binarization is a process of converting (usually) a gray-scale image into a “binary” or a black and white image. A thin image is a binary image that is one pixel wide. A wide binary image is a binary image that preserves at least the shape and width of ridges and the shape of pores.

A minutiae point or minutiae is a small detail in the print pattern and refers to the various ways that ridges can be discontinuous. Examples of minutiae are a ridge termination or ridge ending where a ridge suddenly comes to an end and a ridge bifurcation where one ridge splits into two ridges.

A similarity measure is any measure (also referred to herein interchangeably with the term score) that identifies or indicates similarity of a file print (or record) to a search print (or record) based on one or more given parameters.

A direction field (also known in the art and referred to herein as a direction image) is an image indicating the direction the friction ridges point to at a specific image location. The direction field can be pixel-based, thereby, having the same dimensionality as the original fingerprint image. It can also be block-based through majority voting or averaging in local blocks of pixel-based direction field to save computation and/or improve resistance to noise. A number of methods exist to determine direction and smooth direction images.

A direction field measure or value is the direction assigned to a point (e.g., a pixel location) or block on the direction field image and can be represented, for example, as a slit sum direction, an angle or a unit vector.

A pseudo-ridge is the continuous tracing of direction field points, where for each point in the pseudo-ridge, the tracing is performed in the way that the next pseudo-ridge point is always the non-traced point with smallest direction change with respect to the current point or the several previous points.

A singularity point is a core or a delta.

In a fingerprint pattern, a core is the approximate center of the fingerprint pattern on the most inner recurve where the direction field curvature reaches the maximum.

According to ANSI-INCITS-378-2004 standard, a delta is the point on a ridge at or nearest to the point of divergence of two type lines, and located at or directly in front of the point of divergence.

Level-three features are defined for fingerprint images, for example, relative to level-one and level-two features. Level-one features are the features of the macro-scale, including cores/deltas. Level-two features are the features in more detail, including minutiae location, angles, ridge length and ridge count. Level-three features are of the micro-scale, including pores, ridge shape, ridge gray level distribution and incipient ridges. In comparison to level-one and level-two features which are widely available in current fingerprint images, level-three features are most reliably seen in high resolution, e.g., ≧1000 ppi (pixels per inch) images.

Ridge frequency is defined as the number of ridges per unit length along a vertical direction of local ridge orientation in the fingerprint. A ridge frequency map for a fingerprint image or slap image can be generated that includes this data.

Ridge distance is defined as the distance between two adjacent ridges along a vertical direction of the ridge orientation. It can be found from the inverse of the ridge frequency.

Turning again to FIG. 1, an AFIS that may be used to implement the various embodiments of the present invention described herein is shown and indicated generally at 10. System 10 includes an input and enrollment station 140, a data storage and retrieval device 100, one or more minutiae matcher processors 120, a verification station 150 and optionally one or more secondary matcher processors 160. Embodiments may be implemented in one or more of the verification station 150 and the secondary matcher processor(s) 160, which in turn can be implemented using one or more suitable processing devices, examples of which are listed below.

Input and enrollment station 140 is used to capture fingerprint images to extract the relevant features (minutiae, cores, deltas, binary image, ridge features, etc.) of those image(s) to generate file records and a search record for later comparison to the file records. Thus, input and enrollment station 140 may be coupled to a suitable sensor for capturing the fingerprint images or to a scanning device for capturing a latent fingerprint.

Data storage and retrieval device 100 may be implemented using any suitable storage device such as a database, RAM (random access memory), ROM (read-only memory), etc., for facilitating the AFIS functionality. Data storage and retrieval device 100, for example, stores and retrieves the file records, including the extracted features, and may also store and retrieve other data useful to carry out embodiments. Minutiae matcher processors 120 compare the extracted minutiae of two fingerprint images to determine similarity. Minutiae matcher processors 120 output to the secondary matcher processors 160 at least one set of mated minutiae corresponding to a list of ranked candidate records associated with minutiae matcher similarity scores above some threshold. Secondary matcher processors 160 provide for more detailed decision logic using the mated minutiae and usually some additional features to output either a sure match (of the search record with one or more print records) or a list of candidate records for manual comparison by an examiner to the search record to verify matching results using the verification station 150.

It is appreciated by those of ordinary skill in the art that although input and enrollment station 140 and verification station 150 are shown as separate functional boxes in system 10, these two stations may be implemented in a product as separate physical stations (in accordance with what is illustrated in FIG. 1) or combined into one physical station in an alternative embodiment. Moreover, where system 10 is used to compare one search record for a given person to an extremely large database of file records for different persons, system 10 may optionally include a distributed matcher controller (not shown), which may include a processor configured to more efficiently coordinate the more complicated or time consuming matching processes.

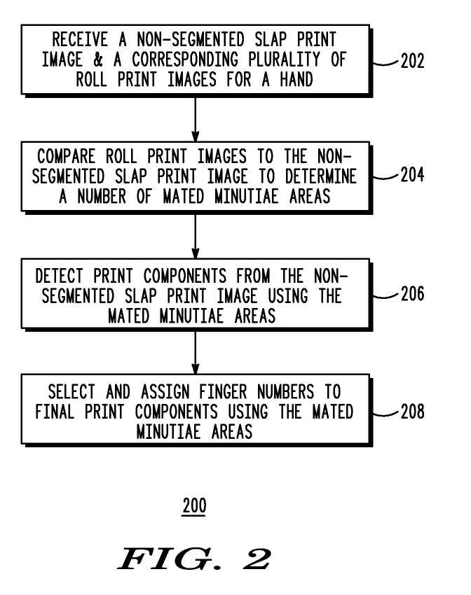

Turning now to FIG. 2, a flow diagram illustrating a method in accordance with some embodiments is shown and generally indicated at 200. Method 200 (and method 300 for that matter) may be performed, for instance, in input and enrollment station 140 and/or verification station 150. In general, method 200 comprises: receiving (202), for a hand, a non-segmented slap print image and a corresponding plurality of roll print images each corresponding to a different finger number; comparing (204) the roll print images to the non-segmented slap print image to determine a number of mated minutiae areas on the non-segmented slap print image; detecting (206) a number of print components from the non-segmented slap print image using the plurality of mated minutiae areas; and selecting (208) a number of final print components from the detected print components and assigning finger numbers to the final print components, using the plurality of mated minutiae areas.

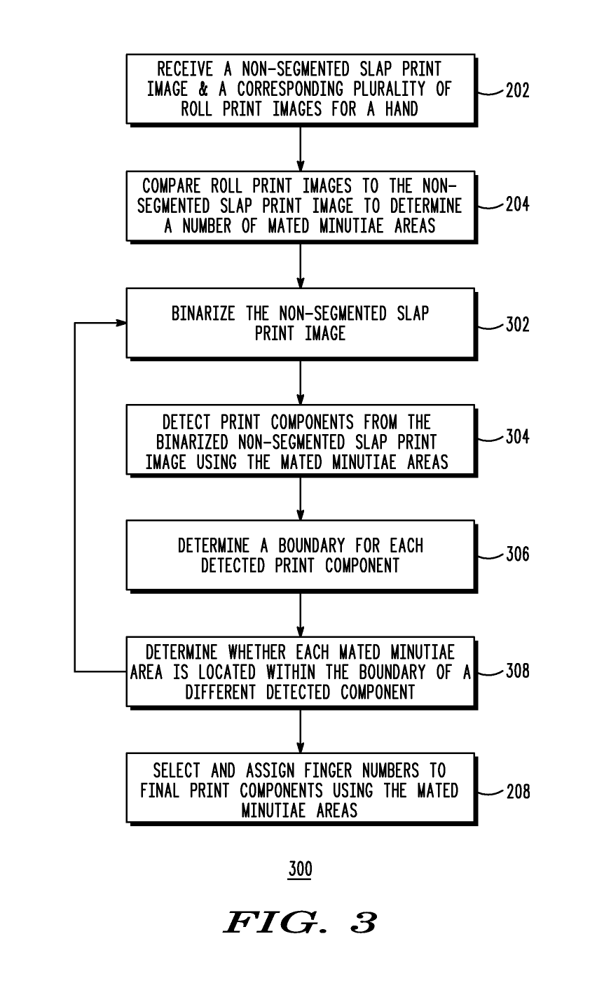

Method 200 may be implemented in any number of ways, and FIG. 3 illustrates a method 300 that is one example of a detailed implementation of method 200. In this illustrative implementation, method 300 is described in terms of a fingerprint image segmentation process (such as one implemented in the AFIS shown in FIG. 1), for ease of illustration. However, it is appreciated that the method may be similarly implemented in biometric image segmentation for other types of print images such as, for instance, toe prints without loss of generality, which are also contemplated within the meaning of the terms “print image” and “fingerprint image” as used in the various teachings described herein. Thus, all types of prints and images are contemplated within the meaning of the terms “print” and “fingerprint” as used in the various teachings described herein.

At 202, for a hand, a non-segmented slap print image and a corresponding plurality of roll print images each corresponding to a different finger number are received into any suitable interface within or into the fingerprint identification system, such as by scanning a ten print card or by a live scan of the fingerprints and slap prints at a work station. The non-segmented slap print image and the corresponding roll images are, using any suitable methods, processed to extract minutiae and core/delta information.

At 204, the minutiae of each roll image is compared to the minutiae of the non-segmented slap print in minutiae matcher processor 120 to determine mated minutiae areas on the non-segmented slap print image. More particularly, if an area generates a matched score that is greater than a matched score threshold, T, (for example a threshold of 35 which can be empirically set) then the area is identified as a mated minutiae area for performing the remainder of method 300. The dimensions of the mated minutia area should follow the convex hull of the mated minutia, which is adaptively constructed according to the found mated minutia set. It is desirable to identify four such mated minutiae areas corresponding to the four fingers on the hand. However, this may not be the case in some instances. For example, deficiencies in fingerprint capture or an enrollee missing a finger may result in less than the four mated minutiae areas being identified.

The non-segmented slap image in many implementations has a resolution of 500 dpi (but could be of a higher or lower resolution depending on system accuracy requirements) and is 1600 pixels×1000 pixels in size. The non-segmented slap image, moreover, usually has 256 gray levels. A copy of the image may be optionally down sampled from 8 to 1 and quantized into gray levels having a range of 16 to 64, more preferably 32 to 64, to increase processing speed. A local mean and dynamic range is calculated for each 13×13 window across the entire down-sampled slap image and compared to four thresholds to binarize (302) the down-sampled image into a two-level image having foreground, e.g., areas corresponding to fingerprint areas, and background, e.g., areas corresponding to non-fingerprint areas.

The four thresholds comprise two global mean thresholds and two global dynamic range thresholds. A pixel is considered part of the foreground when the local mean associated with that area is smaller than a global mean threshold T1 or the local dynamic range is greater than a global mean dynamic range T2 or the local mean is smaller than second global mean threshold T3 and the dynamic range associated with that area is greater than a second global dynamic threshold T4. Otherwise the pixel comprises a background area. The four threshold values can initially be determined from a global mean and a global mean dynamic range calculated for the entire non-segmented slap image. For example, the thresholds T1 and T4 are set X % below the global mean and dynamic range and the thresholds T2 and T3 are set to Y % above the global mean and dynamic range. X and Y are also dynamically set based on the value of global mean and dynamic range found. Background noise such as extraneous print lines, printed letters, smudges, etc., near a boundary of the non-segmented slap print are detected by profiling the area bordering the be binarized image, and the detected noise is deleted from the binarized image.

At 304, fingerprint components are detected from the binarized non-segmented slap print image, which includes determining (306) a boundary associated with each detected fingerprint component and determining (308) whether each mated minutiae area is located within the boundary of a different detected component. Details are as follows.

At least three types of processes are used to detect segmentation boundaries, namely, the detection of connected components, the splitting of weakly connected components in x and y axis directions and the deletion of small components and line shape components. Weakly connected components are defined as those component images having no more than two pixels connecting two components in the image. A line shape component is referred to as a component having width no more than 6 pixels wide. A small component is defined by the number of pixels contained in the component image being less than a threshold value T. The selection of T relates to a down-sample rate, and is 105 in one illustrative implementation. Each remaining detected component is characterized by its boundary, central line, component size and component height.

An approximate boundary for each remaining detected component is found by scanning each component from left to right and from top to bottom in the following manner. The left most from white to black transition cell is the left boundary of the component for a row, and the right most from black to white transition cell is the right boundary of the component for that row. The detected boundary is further convexized to adjust the shape of the component to an appropriate fingerprint shape. The convex boundaries are computed by considering successive left most pixels (as well as right most pixels) of neighboring rows and identifying whether the slope is increasing or decreasing monotonically (a necessary and sufficient condition for the convex hull). If this condition is violated, the left or right most pixel of the current row is adjusted to comply with this condition by making it equal to the left most or right most pixel of the current or the previous row.

Once the boundaries are determined for each remaining fingerprint component, the process does not automatically proceed to the selecting (208) of the final fingerprint components from the detected fingerprint components. Instead, the remaining detected components are compared with the mated minutiae areas, and the size of each component is analyzed to determine whether the components are correctly detected. More particularly, the process determines (308) whether each mated minutiae area is located within a different one of the detected fingerprint components and determines whether each component satisfies a size threshold indicating that the component has an appropriate fingerprint size (Since the binarized components may be derived from a down sampled image, the threshold may be selected depending on the image size, resolution and down sample ratio. The threshold can be empirically determined and may be set to preserve the fingerprint shape and size. For instance, the threshold can be set to 1000 in this illustration).

In many instances, each of the mated minutiae areas is located within the boundary of a different fingerprint component, and the corresponding components are of a suitable size, and the process proceeds to 208. However, where either condition is not met, to obtain better fingerprint components, at least portions of steps 302, 304, 306 and 308 are iteratively performed until one or more of the following parameters are satisfied: each mated minutiae area falls within the boundary of a different one of the detected print components; each of the detected print components having a mated minutiae area within its boundary has a size that is larger than a pre-determined size threshold; a stopping criterion is reached. The stopping criterion can be, for instance, that a number of strategies for re-binarizing are tried without resulting in both the size and the mated minutiae area conditions being fulfilled.

Moreover, during these iterations, binarizing is not limited to being based on the gray statistical image and fixed thresholds. It can be performed based on one or more of the following: adjusting, from a previous iteration, at least one of four thresholds used to binarize the non-segmented slap print image; using a different resolution for the non-segmented slap print image than a resolution used for a previous iteration; a direction map generated for the non-segmented slap print image; a frequency map generated for the non-segmented slap print image; gray statistical data generated for the non-segmented slap print image.

For example, if one of the mated minutiae areas is not located within the boundary of a detected component, or two mated minutiae areas are located within the boundary of a single detected component, change the thresholds up and down within a reasonable range (e.g., 20%) to re-binarize the local area of the down-sampled non-segmented slap image around the mated minutiae area and the component area. If the component in the local binarized area still does not contain the mated minutiae area or the component still contain two mated areas, go back to the corresponding area of the original image (which has a different resolution from the down-sampled image) and re-threshold the local area again. If the mated minutiae area still does not have a corresponding binary component, binarize the local area using the direction map or the ridge frequency map until each mated minutiae area is in one of components. If the above process still does not detect a corresponding component for the mated minutiae area, use the mated area (the convex hull of the mated minutia set) as a component and go to 208.

In another example, if the size or width of component is too small, change the thresholds up and down within a reasonable range (e.g., 20%) to re-binarize the local area of the down-sampled non-segmented slap image around the mated minutiae area and the component area. If the size or width of the component in the local binarized area is still too small, go back to the corresponding area of original image and re-threshold the local area again. After this, if the size and width of the component is still too small, binarize the local area using the direction map or the ridge frequency map to check whether the size and width of component meets the desired values. If the above process still not detect a corresponding component, keep the size and go to 208.

In another embodiment the core and delta or a crease and a cat scratch below the crease can be used to help to identify a first joint area of fingerprint. When a core or a delta is detected with high confidence, a fingerprint component is present with high confidence as well. Accordingly, a 256×256 region around core or delta is definitely a fingerprint component. Similarly, if a crease and the cat scratches below the crease can be reliably detected, a 256×256 region above crease or cat scratches is definitely a fingerprint component.

At 208, a final set of fingerprint components are selected from the detected components, and finger numbers are assigned to these final fingerprint components. In selecting the final fingerprint components, an orientation of each of the detected components is estimated based on the boundary of each remaining detected fingerprint component. To estimate the orientation of each component, the center points of left and right boundaries are first found. Based on these points, a central line is estimated. The orientation of the component is the slope of the estimated central line. Each component orientation may be further adjusted by determining an average orientation of the four largest detected components. The orientation of each component in the slap print image is represented by a central line through each component. With orientation of each component being determined, the selecting of the final components and the finger number assigning are performed, which can be done using known methods based on geometrical relationship between components and relative distance between the tips of each component. However, in accordance with the teachings herein, the selecting of the final components and the finger number assigning are performed further based on the matching results between the roll and slap images.

For example, To further determine substantially inconsistent fingerprint components: a plurality of zones are determined, with each zone comprising a left boundary line and a right boundary line; within each zone, all detected print components are identified; and for each zone, a component is selected having located therein a mated minutiae area, and if no such component is identified, a topmost component in that zone is selected. More particularly, at least two zone lines are placed at a left and a right boundary of each remaining detected component. Each zone line should have substantially the same direction and orientation as the central line. If a mated minutiae area is not located within the zone, select a topmost component as a final fingerprint component. Otherwise select the fingerprint component having located therein a mated minutiae area, and delete the remaining components in the same zone. The remaining detected components are sorted left to right of the normal direction of finger orientation.

The following cases may be encountered in selecting the final fingerprint components. First, where the number of detected print components is at least four; the number of mated minutiae areas is four; and each of the mated minutiae areas is located within the boundary of a different one of the detected print components—the four detected print components having the mated minutiae areas within their boundaries are selected as the final print components and any additional detected components are deleted. The final print components are assigned finger numbers 2, 3, 4 and 5 from left to right if the hand is a right hand or are assigned finger numbers 10, 9, 8 and 7 from left to right if the hand is a left hand.

Second, where the number of detected print components is at least four; and three mated minutiae areas are located within the boundary of a different one of three of the detected print components—the three detected print components having the mated minutiae areas within their boundaries are selected as three of the final print components; and one of the other detected print components is selected as the fourth final print component based on at least one of a hand geometric shape pattern comparison, and size of the other detected print components. The final print components are assigned finger numbers 2, 3, 4 and 5 from left to right if the hand is a right hand or are assigned finger numbers 10, 9, 8 and 7 from left to right if the hand is a left hand. In both of the above cases, the process further checks the consistency between each assigned finger number and the finger number associated with the corresponding roll-to-slap mated minutiae area, and outputs a flag for any inconsistency in order to invoke a manual review of the suspect fingerprint component.

With further regard to detecting the fourth final fingerprint component in the second case, after selecting the three final components, the remaining detected components are each compared to the three already selected components to detect a fourth component that forms a four hand geometrical shape pattern. A four hand geometric shape pattern meets these constraints: finger 5 is lower than finger 4 in hand orientation; finger 2 is lower than finger 3 in hand orientation; finger 10 is lower than finger 9 in hand orientation; finger 7 is lower than finger 8 in hand orientation. Alternatively, a four hand geometric shape pattern meets these constraints: (a) the most left or most right distances to neighbor finger components increases in an ascending order and (b) the relative angles from most left or most right component to neighbor components increases in an ascending order. The remaining component that forms the hand geometrical shape with the other three selected components is selected as the fourth final fingerprint component. Otherwise, if no component meets the constraints, select the largest component.

In a third case, where the number of detected print components is less than four; and a different mated minutiae area is located within the boundary each of the detected print components—all of the detected print components are selected as final print components. Based on the component distance and relative distance between the neighbor components, the final fingerprint components are assigned finger numbers. If a fingerprint component does not meet the hand geometric shape constraints, or the assigned finger number is inconsistent with the corresponding roll-to-slap finger number, the component is flagged for manual review.

Where the final fingerprint components are detected from a down-sampled slap image, they are converted to a coordinate system for the original slap image. If a flag is on, a manual human examination is performed on the flagged component to confirm accuracy. In this manner, more accurate segmented finger components can be automatically generated from a non-segmented slap fingerprint image while minimizing human verification.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and apparatus for slap print segmentation described herein. The non-processor circuits may include, but are not limited to, a radio receiver, a radio transmitter, signal drivers, clock circuits, power source circuits, and user input devices. As such, these functions may be interpreted as steps of a method to perform the slap print segmentation described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Both the state machine and ASIC are considered herein as a “processing device” for purposes of the foregoing discussion and claim language.

Moreover, an embodiment can be implemented as a computer-readable storage medium having computer readable code stored thereon for programming a computer (e.g., comprising a processing device) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method comprising:
receiving, for a hand, a non-segmented slap print image and a corresponding plurality of roll print images each corresponding to a different finger number;
comparing the roll print images to the non-segmented slap print image to determine a number of mated minutiae areas on the non-segmented slap print image;
detecting a number of print components from the non-segmented slap print image using the plurality of mated minutiae areas; and
selecting a number of final print components from the detected print components and assigning finger numbers to the final print components, using the plurality of mated minutiae areas.

2. The method of claim 1, wherein detecting print components comprises:
determining a boundary for each detected print component;
determining whether each mated minutiae area is located within the boundary of a different one of the detected components.

3. The method of claim 2 further comprising:
binarizing the non-segmented slap print image, wherein the detecting of the print components is performed on the binarized slap print image.

4. The method of claim 3 further comprising iteratively performing the binarizing of the non-segmented print image and at least part of the detecting of the print components until at least one of the following is detected:
each mated minutiae area falls within the boundary of a different one of the detected print components;
each of the detected print components having a mated minutiae area within its boundary has a size that is larger than a pre-determined size threshold;
a stopping criterion is reached.

5. The method of claim 4, wherein for at least one iteration, binarizing is performed based on at least one of:
adjusting, from a previous iteration, at least one of four thresholds;
using a different resolution for the non-segmented slap print image than a resolution used for a previous iteration;
a direction map generated for the non-segmented slap print image;
a frequency map generated for the non-segmented slap print image;
statistical data generated for the non-segmented slap print image.

6. The method of claim 2, wherein:
the number of detected print components is at least four;
the number of mated minutiae areas is four;
each of the mated minutiae areas is located within the boundary of a different one of the detected print components;
the four detected print components having the mated minutiae areas within their boundaries are selected as the final print components;
the final print components are assigned finger numbers 2, 3, 4 and 5 from left to right if the hand is a right hand or are assigned finger numbers 10, 9, 8 and 7 from left to right if the hand is a left hand.

7. The method of claim 2, wherein:
the number of detected print components is at least four;
three mated minutiae areas are located within the boundary of a different one of three of the detected print components;
the three detected print components having the mated minutiae areas within their boundaries are selected as three of the final print components;
one of the other detected print components is selected as the fourth final print component based on at least one of a hand geometric shape pattern comparison, and size of the other detected print components;
the final print components are assigned finger numbers 2, 3, 4 and 5 from left to right if the hand is a right hand or are assigned finger numbers 10, 9, 8 and 7 from left to right if the hand is a left hand.

8. The method of claim 2, wherein:
the number of detected print components is less than four,
a different mated minutiae area is located within the boundary each of the detected print components,
all of the detected print components are selected as final print components;
using the finger numbers corresponding to the roll print images, the final print components are assigned finger numbers;
the method further comprising flagging a final print component for manual review if the final print component fails to meet hand geometric shape constraints.

9. The method of claim 2, wherein selecting the final print components comprises:
determining a plurality of zones, with each zone comprising a left boundary line and a right boundary line;
identifying all detected print components in each zone; and
for each zone, selecting a component having located therein a mated minutiae area, and if no component has located therein a mated minutiae area, selecting a topmost component.

10. A system comprising:
an interface receiving, for a hand, a non-segmented slap print image and a corresponding plurality of roll print images each corresponding to a different finger number; and
a processing device,
comparing the roll print images to the non-segmented slap print image to determine a number of mated minutiae areas on the non-segmented slap print image,
binarizing the non-segmented slap print image,
detecting a number of print components from the binarized non-segmented slap print image using the plurality of mated minutiae areas, wherein the detecting comprises,
determining a boundary for each detected print component,
determining whether each mated minutiae area is located within the boundary of a different one of the detected components, and
selecting a number of final print components from the detected print components and assigning finger numbers to the final print components, using the plurality of mated minutiae areas,
wherein the binarizing and at least part of the detecting of the print components is iteratively performed until at least one of the following is detected:
each mated minutiae area falls within the boundary of a different one of the detected print components;
each of the detected print components having a mated minutiae area within its boundary has a size that is larger than a pre-determined size threshold;
a stopping criterion is reached.

11. The system of claim 10, wherein the system is an Automatic Fingerprint Identification System (AFIS).

12. A computer-readable storage medium having computer readable code stored thereon for programming a computer to perform a method upon receiving, for a hand, a non-segmented slap print image and a corresponding plurality of roll print images each corresponding to a different finger number, the method comprising:
comparing the roll print images to the non-segmented slap print image to determine a number of mated minutiae areas on the non-segmented slap print image;
binarizing the non-segmented slap print image;
detecting a number of print components from the binarized non-segmented slap print image using the plurality of mated minutiae areas, wherein the detecting comprises;
determining a boundary for each detected print component;
determining whether each mated minutiae area is located within the boundary of a different one of the detected components; and
selecting a number of final print components from the detected print components and assigning finger numbers to the final print components, using the plurality of mated minutiae areas.

13. The computer-readable storage medium of claim 12, wherein the binarizing and at least part of the detecting of the print components is iteratively performed until at least one of the following is detected:
each mated minutiae area falls within the boundary of a different one of the detected print components;
each of the detected print components having a mated minutiae area within its boundary has a size that is larger than a pre-determined size threshold;
a stopping criterion is reached.

14. The computer-readable storage medium of claim 13, wherein the computer readable storage medium comprises at least one of a hard disk, a CD-ROM, an optical storage device, a magnetic storage device, a ROM (Read Only Memory), a PROM (Programmable Read Only Memory), a EPROM (Erasable Programmable Read Only Memory), a EEPROM (Electrically Erasable Programmable Read Only Memory) and a Flash memory.
